(19) United States
(12) Patent Application Publication
(10) Pub. No.: US 2010/0165615 A1
(43) Pub. Date: Jul. 1, 2010

(54) LIGHTING DEVICE WITH PULSATING FLUID COOLING

(75) Inventors: Ronaldus Maria Aarts, Eindhoven (NL); Clemens Johannes Maria Lasance, Eindhoven (NL); Joris Adelbert Maria Nieuwendijk, Eindhoven (NL); Okke Ouweltjes, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/663,527

(22) PCT Filed: Jun. 9, 2008
(86) PCT No.: PCT/IB2008/052254

§ 371 Date: Dec. 8, 2009

(30) Foreign Application Priority Data
Jun. 14, 2007 (EP) 07110265.1

(51) Int. Cl. F21S 8/00

(52) U.S. Cl. 362/227

(57) ABSTRACT

An illumination device (1) comprising: at least one light emitting device (5); and a suspension structure (2), suspending the at least one light emitting device (5) in a desired position. Further, the illumination device (1) has a transducer (6), adapted to generate pressure waves at a drive frequency; wherein the suspension structure (2) is utilized as a flow guiding structure (7), having a first end adapted to receive the pressure waves from the transducer, and a second end adapted to generate a pulsating net output flow towards the at least one light emitting device (5), thereby cooling the at least one light emitting device (5). By utilizing the suspension structure itself as flow guiding structure cooling can be integrated in a cost efficient way. Further, no additional space is required to accommodate the flow guiding structure.

### FIELD OF THE INVENTION

The present invention relates to pulsating fluid cooling, i.e. cooling where a transducer induces an oscillation creating a pulsating fluid stream that can be directed towards an object that is to be cooled. More particularly the present invention relates to pulsating fluid cooling for an illumination device.

### BACKGROUND OF THE INVENTION

The need for cooling has increased in various applications due to higher heat flux densities resulting from newly developed electronic devices, being, for example, more compact and/or higher power than traditional devices. Examples of such improved devices include, for example, higher power semiconductor light-sources, such as light-emitting diodes, and large-area devices such as flat TVs and luminaires.

As an alternative to cooling by fans, document WO 2005/008348 discloses a synthetic jet actuator and a tube for cooling purposes. The tube is connected to a resonating cavity, and a pulsating jet stream is created at the distal end of the tube, and can be used to cool an object. The cavity and the tube form a Helmholtz resonator, i.e. a second order system where the air in the cavity acts as a spring, while the air in the tube acts as the mass.

A drawback with this type of system is that for many applications the resonating cavity and the tube tend to require a considerable space in order to achieve reasonable performance in terms of efficient cooling, and reasonable noise level.

### SUMMARY OF THE INVENTION

In view of the above-mentioned and other drawbacks of prior art, a general object of the present invention is to provide improved cooling for an illumination device while maintaining compactness and low audibility.

According to the present invention, these and other objects are achieved by an illumination device comprising:

at least one light emitting device; and

a suspension structure, suspending the at least one light emitting device in a desired position; wherein the illumination device has a transducer, adapted to generate pressure waves at a drive frequency; wherein the suspension structure is utilized as a flow guiding structure, having a first end adapted to receive the pressure waves from the transducer, and a second end adapted to generate a pulsating net output flow towards the at least one light emitting device, thereby cooling the at least one light emitting device.

By utilizing the suspension structure itself as flow guiding structure, cooling can be integrated in the device in a cost efficient way. Further, no additional space is required to accommodate the flow guiding structure. This enables efficient cooling of the illumination device while maintaining low audibility and not requiring a larger illumination device.

For large suspension structures, such as a street light, the full length of the structure (i.e. the pole) can be exploited, yielding a high Q (quality factor of the flow guiding structure), giving a strong synthetic jet cooling the light emitting device, such that a higher light output can be obtained than without this cooling.

The present invention is based upon the realization that due to the flexibility allowed when it comes to the shape of the flow guiding structure; no separate structure is needed for this purpose. Instead the existing suspension structure of the illumination device can be adapted and utilized as flow guiding structure, thereby enabling a cost efficient and a compact design.

The non-published European patent application 06111434.4 [PH004495 EP1] discloses a cooling device comprising a transducer generating pressure waves, and a tube functioning as a flow guiding structure. This is an example of a cooling device that can be integrated in an illumination device according to the present invention.

The light emitting device may be associated with a high heat flux density, and thus require cooling. This may be the case for, for example, newly developed electronic devices being more compact and/or having higher power than traditional devices. Examples of such devices are higher power semiconductor light-sources, such as light emitting diodes.

The suspension structure may extend from a support end, supporting the illumination device, to a suspension end, suspending the light emitting device in a desired position.

The support end may be arranged at a fixed surface. Depending on the application the fixed surface could, for example, be the ground, the floor, a wall, a table or the ceiling.

The suspension structure may be arranged to suspend a plurality of light emitting devices in desired positions relative each other.

The suspension structure may have a planar extension.

According to an embodiment, the length of the flow guiding structure may be greater than λ/10, where λ is the wavelength of the pressure waves, which has been found to be sufficiently long to get desired system resonances. Here, the flow guiding structure acts as a transmission line, which applies a velocity gain to the pulsating flow. An even better effect has been found for flow guiding structures having a length greater than λ/8, and an even better effect for a for flow guiding structures having a length greater than λ/5.

Other objectives, features and advantages will appear from the following detailed disclosure, from the attached dependent claims as well as from the drawings.

### BRIEF DESCRIPTION OF THE DRAWINGS

The above, as well as additional objects, features and advantages of the present invention, will be better understood through the following illustrative and non-limiting detailed description of preferred embodiments of the present invention, with reference to the appended drawings, where the same reference numerals will be used for similar elements, wherein:

FIG. 1 illustrates an embodiment of the present invention implemented in a street light.

FIG. 2 is a cross-section of a street light illustrating a further embodiment of the present invention having a coil shaped flow guiding structure.

FIG. 3 is a cross-section of a street light illustrating a further embodiment of the present invention having a flow guiding structure shaped as a labyrinth.

FIG. 4 illustrates a further embodiment of the present invention in a desk lamp having a ductile suspension structure.

FIG. 5 illustrates a further embodiment of the present invention for highway illumination having an Y-shaped suspension structure.

FIG. 6 is a cross-section of a ceiling lamp illustrating yet another embodiment of the present invention where a plurality of light emitting devices are suspended in desired positions relative each other.

### DETAILED DESCRIPTION OF PREFERRED EMBODIMENTS

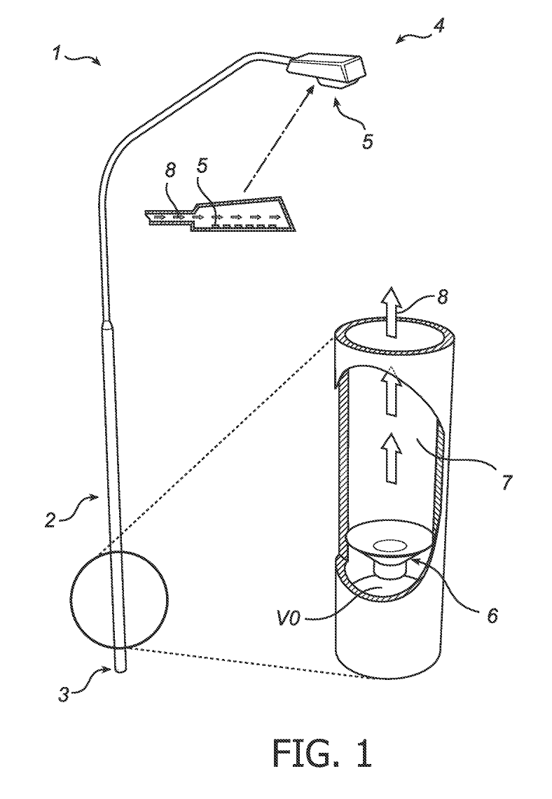

The illumination device 1 illustrated in FIG. 1 is a street light 1. The suspension structure 2 extends from a support end 3, where the street light 1 is anchored to the ground, to a suspension end 4, where a plurality of light emitting devices 5, here being light emitting diodes (LEDs) 5, are suspended. The suspension structure 2 here has an angled shape to position the LEDs 5 in a desired position. A transducer 6, such as an electrodynamic loudspeaker, is arranged within the suspension structure 2 near the support end 3. A hollow portion of the suspension structure 2 forms a flow guiding structure 7 between the transducer 6 and the LEDs 5. The flow guiding structure 7 may have a rectangular cross-section, but may also have any other cross-section as appropriate. The flow guiding structure 7 may have smooth walls to yield a higher quality factor Q.

A cavity volume can be provided between the transducer 6 and the flow guiding structure 7. This cavity volume is not required, but may be advantageous to compensate different diameters of the transducer 6 and the flow guiding structure 7. As illustrated in FIG. 1 there may also be a cavity volume V0 provided behind the transducer 6. The direction of the transducer 6 is not of importance and might be reversed.

In operation the transducer 6 induces an oscillation creating a pulsating fluid stream 8. The flow guiding structure 7 promotes a velocity gain of the pulsating fluid stream 8, which enables more efficient cooling of the LEDs 5. The velocity gain is inversely proportional to sin(2πL/λ)+cos (2πL/λ), where λ is the wave length of the pressure waves, and L is the length of the flow guiding structure. In particular, a standing wave is created in the flow guiding structure 7 when its length is equal to (2n+1) λ/4, causing an especially advantageous velocity gain.

In a preferred embodiment the lowest resonance frequency is used as an operating frequency. However, in cases where this frequency is too low, because the flow guiding structure 7 is very long, a higher frequency may be selected as the operating frequency.

In the illustrated arrangement the supporting structure 2 enables a flow guiding structure 7 without any sharp turns, whereby a particularly large frequency selective amplification, or in other words, high acoustic quality factor (Q), is obtained.

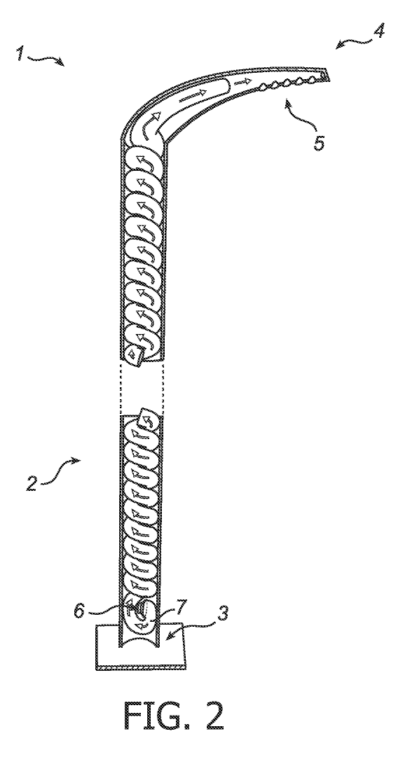

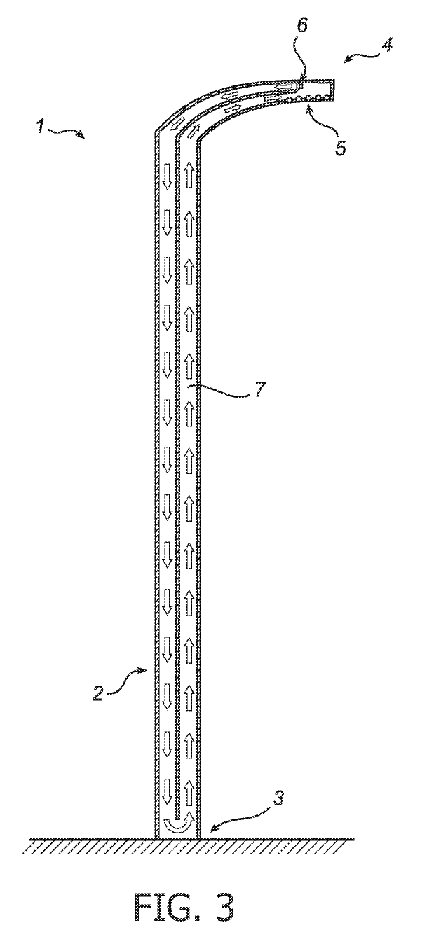

However, as exemplified in FIG. 2-3, the flow guiding structure 7 may be, for example, substantially coil shaped or have some other arrangement that is more compact than a straight tube, such as a labyrinth, thereby enabling further space-saving. Modifying the shape of the flow guiding structure 7 also enables the transducer 6 to be located in an alternative position. For example, as illustrated in FIG. 3, a flow guiding structure 7 shaped as a labyrinth may enable the transducer 6 to be located near the suspension end 4 rather than near the support end 3.

Having the transducer 6 situated near an end, whether it is the support end 3 or the suspension end 4, enables easy maintenance, such as, for example, replacement of the transducer 6. In an alternative embodiment the transducer 6 can be placed outside the suspension structure 2, with an acoustic coupling between the transducer 6 and the flow guiding structure 7.

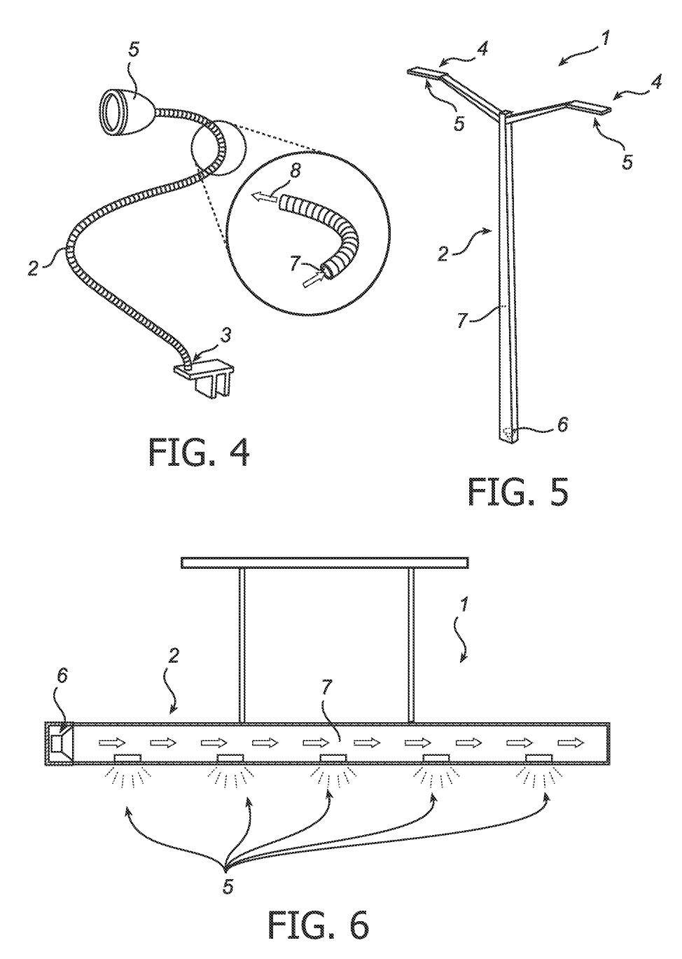

The person skilled in the art realizes that the present invention by no means is limited to the preferred embodiments. For example, the suspension structure 2 may vary in shape and dimensions depending on the application. The suspension structure 2 can be straight, angled, or have any curvature as exemplified in FIG. 1-6. Although the suspension structure 2 typically is rigid, it may equally well be ductile, such as in a desk lamp where a user can bend the suspension structure (also utilized as flow guiding structure 7) to direct the light in a desired direction as illustrated in FIG. 4. Also, the suspension structure 2 may branch off, as exemplified by the highway illumination illustrated in FIG. 5 having an Y-shaped suspension structure 2 with LEDs 5 suspended at two suspension ends 4 to illuminate roadways going in both directions. In this example the flow guiding structure 7 also branch off, enabling cooling of LEDs 5 in the both locations. The suspension structure is not necessarily arranged to suspend LEDs in relation to a fixed surface. As illustrated by the ceiling lamp in FIG. 6, the suspension structure 2 may equally well be arranged to suspend a plurality of LEDs 5 in desired positions relative each other. The suspension structure 2, is here utilized as a flow guiding structure 7 enabling cooling of each LED. The LEDs may be placed within the flow guiding structure 7, or outside thereof. As the LEDs are located outside the flow guiding structure 7, the flow guiding structure 7 may have an opening, or branch off, for each LED location.

The invention has mainly been described above with reference to a few embodiments. However, as is readily appreciated by a person skilled in the art, other embodiments than the ones disclosed above are equally possible within the scope of the invention, as defined by the appended claims.

1. An illumination device comprising:
at least one light emitting device;
a suspension structure, suspending said at least one light emitting device in a desired position; and
a transducer configured to generate pressure waves at a drive frequency; wherein said suspension structure is utilized as a flow guiding structure, having a first end configured to receive said pressure waves from the transducer, and a second end configured to generate a pulsating net output flow towards said at least one light emitting device, thereby cooling said at least one light emitting device.

2. An illumination device according to claim 1, wherein said at least one light emitting device is associated with a high heat flux density.

3. An illumination device according to claim 1, wherein the suspension structure extends from a support end, supporting the illumination device, to a suspension end, suspending the at least one light emitting device in a desired position.

4. An illumination device according to claim 3, wherein the support end is arranged at a fixed surface.

5. An illumination device according to claim 1, wherein the suspension structure is arranged to suspend a plurality of light emitting devices in desired positions relative each other.

6. An illumination device according to claim 5, wherein the suspension structure has a planar extension.

7. An illumination device according to claim 1, wherein the flow guiding structure has a length (L) greater than λ/10, where λ is the wave length of the pressure waves.
